(19) United States
(12) Patent Application Publication
(10) Pub. No.: US 2017/0185985 A1
(43) Pub. Date: Jun. 29, 2017

(54) SALES REGISTRATION APPARATUS, PROGRAM, AND SALES REGISTRATION METHOD

(71) Applicant: NEC Corporation, Tokyo (JP)

(72) Inventors: Tomoyuki HARADA, Tokyo (JP); Kota IWAMOTO, Tokyo (JP); Tetsuo INOSHITA, Tokyo (JP); Soma SHIRAISHI, Tokyo (JP); Hiroshi YAMADA, Tokyo (JP); Jun KOBAYASHI, Tokyo (JP); Eiji MURAMATSU, Tokyo (JP); Hideo YOKOI, Tokyo (JP)

(73) Assignee: NEC Corporation, Tokyo (JP)

(21) Appl. No.: 15/129,743

(22) PCT Filed: Mar. 25, 2015
(86) PCT No.: PCT/JP2015/060306

§ 371 Date: Sep. 27, 2016

(30) Foreign Application Priority Data
Mar. 28, 2014 (JP) 2014-068502

(51) Int. Cl. G06Q 20/20; G06K 19/06; G07G 1/00; G06N 99/00; G07G 1/14

(52) U.S. Cl. CPC G06Q 20/208; G06N 99/005; G07G 1/14; G07G 1/0045; G06K 19/06028; G06K 9/6267

(57) ABSTRACT

When the presence of a subject is detected within the image-capturing range of an image sensor, a frame image is created to acquire the identifier of a corresponding product. A feature quantity of the frame image is stored in a storage device in connection with the acquired identifier, and product information associated with the identifier is acquired from a product information DB to perform sales processing.

### TECHNICAL FIELD

The present invention relates to an apparatus that registers sales of products in sales stores and the like, i.e. a so-called cash register, a POS (Point of Sales) terminal, and the like. The present invention relates, in particular, to accumulation of learning result data being necessary when a product is subjected to image recognition.

### BACKGROUND ART

In general, a POS terminal reads a bar code such as a JAN (Japanese Article Number) code affixed to a product, by a bar code reader, acquires code information for identifying the product, queries a product database for the code information to acquire information about the product such as a product name and a unit price of the product, and executes sales processing.

PTL 1, for example, proposes a POS system in which so-called general recognition of object is executed by a computer to identify a product. Instead of executing identification by a bar code or in combination with use of identification by the bar code, the POS system captures the product by a camera, and creates an image of the product. Further, the POS system calculates a feature quantity from the captured image, and compares the calculated feature quantity with feature quantities of various product images previously registered on an image recognition database (hereinafter, abbreviated as an image recognition DB).

In general, image recognition includes a learning phase and a recognition phase. As illustrated in FIG. 19, in the learning phase, an image of each product of a product group to be recognized by a POS system is prepared as a learning image, learning is executed by extracting a feature quantity from the learning image, and a result of the leaning is accumulated as learning result data. In the recognition phase, when an image of a certain product is created as an input image, a feature quantity is extracted from the input image by the same technique as the feature quantity extraction in the learning phase, the feature quantity and a feature quantity of each product accumulated as the learning result data are compared so as to recognize the product, and a recognition result is obtained.

In this manner, to recognize a product by image recognition, it is necessary to previously prepare the learning result data. In other words, it is meant that to execute image recognition of a product, prior to execution of image recognition, for all products to be subjected to image recognition, it is necessary to associate a learning image used as a determination criterion upon recognition or data of a feature quantity extracted from the learning image with a product ID (Identifier) indicating the product and store the association in a storage device in a POS system.

Processing time necessary for storing an association between a learning image/a feature quantity and a product ID in a storage device is prolonged depending on the number of types of products dealt with in a store. Specifically, in the store dealing with a significantly wide variety of products as in a super market or a convenience store, a considerable amount of time is needed.

Regarding creation of learning result data, PTL 2, for example, describes a method for creating a recognition dictionary equivalent to the learning result data.

A product reading device described in PTL 2 includes a product recognition mode and a recognition dictionary creation mode as operation modes. To create a recognition dictionary corresponding to the learning result data, the recognition dictionary creation mode is selected from a menu screen displayed on a touch panel. Note that upon moving to the recognition dictionary creation mode, an operator is requested to execute an explicit operation for instructing the product reading device to move to the recognition dictionary creation mode. This can be understood from description that it is preferable to limit, by a password input or the like, operators who are able to select the recognition dictionary creation mode (paragraph [0024] in PTL 2).

Further, according to PTL 2, after moving to the recognition dictionary mode, an operator first inputs a product ID of a dictionary creation target product by using a keyboard, a touch panel, or the like. Then, while holding the product over a reading window of the product reading device, the operator inputs an image-capturing key and captures an image of the product (paragraphs [0032] to [0037], and FIG. 7 in PTL 2).

### CITATION LIST

### Patent literature

[PTL 1] Japanese Laid-open Patent Publication No. 2010-237886

[PTL 2] Japanese Laid-open Patent Publication No. 2013-246790

### SUMMARY OF INVENTION

### Technical Problem

According to the conventional technique, an operation intended for only accumulation of learning result data has been requested to an operator or the like. An operation intended to execute processing necessary upon accumulating learning result data, i.e. only a series of processing including creating a product image by image-capturing a product, calculating a feature quantity from the product image, and recording the feature quantity as learning result data by being associated with a corresponding product ID or the like, has been requested to an operator.

Specifically when such an operation is executed using a POS terminal of a store, since it is difficult to execute the operation during the business hours, it is frequently necessary to prepare time for accumulation processing of learning result data outside of the business hours. Therefore, an accumulation speed of the learning result data is low, and as a result, there is a situation in which it is difficult to improve recognition accuracy based on the accumulation of learning result data.

The present invention has been achieved in view of such the situation, and a problem intended to be solved by the present invention is to provide a technique for reducing labor and time to prepare learning result data necessary upon executing image recognition.

### Solution to Problem

To solve the above-described problem, the present invention provides, as one aspect thereof, a sales registration apparatus includes, capturing means for creating an image by capturing a subject; identification means for acquiring an identifier relating to a product that is the subject; and storage means for storing, upon execution of both creation of the image by the capturing means and acquisition of the identifier by the identification means for sales processing as a trigger, at least one of the image and a feature quantity created based on the image and the identifier in association with each other.

The present invention provides, as another aspect, an information processing device connectable, via a network, to another information processing device. The information processing device includes: image-capturing means for creating an image by capturing a subject, and identification means for acquiring an identifier relating to a product that is the subject. The information processing device further includes storage means for storing, upon execution of both creation of the image by the capturing means and acquisition of the identifier by the identification means for sales processing as a trigger, at least one of the image and a feature quantity created based on the image and the identifier in association with each other.

The present invention provides, as another aspect, an information processing system includes, image-capturing means for creating an image by capturing a subject; identification means for acquiring an identifier relating to a product that is the subject; and storage means. Upon execution of both creation of the image by the capturing means and acquisition of the identifier by the identification means for sales processing as a trigger, the storage means stores at least one of the image and a feature quantity created based on the image and the identifier in association with each other.

The present invention provides, as another aspect, a program causing a computer to function as, capturing means for creating an image by capturing a subject; identification means for acquiring an identifier relating to a product that is the subject; and storage means for storing, upon execution of both creation of the image by the capturing means and acquisition of the identifier by the identification means for sales processing as a trigger, at least one of the image and a feature quantity created based on the image and the identifier in association with each other.

The present invention provides, as another aspect, a sales registration method including a capturing stage of creating an image by capturing a subject; an identification stage of acquiring an identifier relating to a product that is the subject; and a storage stage of storing, upon execution of both creation of the image by the capturing stage and acquisition of the identifier by the identification stage for sales processing as a trigger, at least one of the image and a feature quantity created based on the image and the identifier in association with each other.

### Advantageous Effects of Invention

According to the present invention, in a sales registration apparatus, with an operation executed by an operator upon causing a machine to recognize a product, sales processing can be executed while an image of the product is accumulated in association with an identifier of the product. Accordingly, collection of learning result data necessary for image recognition of a product can be performed simultaneously with sales registration of the product.

### BRIEF DESCRIPTION OF DRAWINGS

FIG. 1 is a block diagram of a sales registration apparatus 1 of an exemplary embodiment of the present invention.

FIG. 2 is a diagram illustrating an example of a record structure of an image recognition DB (Data Base) 6.

FIG. 3 is a diagram illustrating another example of the record structure of the image recognition DB 6.

FIG. 4 is a diagram illustrating further another example of the record structure of the image recognition DB 6.

FIG. 5 is a diagram illustrating an example of a record structure of a product information DB 7.

FIG. 6 is a flowchart for illustrating an operation of the sales registration apparatus 1.

FIG. 7 is a block diagram of a sales registration apparatus 100 of Example 1 according to the present invention.

FIG. 8 is a diagram for illustrating an example of a record structure in another product information DB 7 of the sales registration apparatus 100.

FIG. 9 is a flowchart for illustrating an operation of the sale registration apparatus 100.

FIG. 10 is a block diagram of a sales registration apparatus 200 according to Example 2 of the present invention.

FIG. 11 is a diagram for illustrating an example of a record structure of another image recognition DB 6 of the sales registration apparatus 200.

FIG. 12 is a diagram for illustrating an example of a record structure of another product information DB 7 of the sales registration apparatus 200.

FIG. 13 is a diagram illustrating an example of values stored on the image recognition DB 6 of the sales registration apparatus 200.

FIG. 14 is a diagram illustrating an example of values stored on the product information DB 7 of the sales registration apparatus 200.

FIG. 15 is a flowchart for illustrating an operation of the sales registration apparatus 200.

FIG. 16 is a flowchart for illustrating an operation of the sales registration apparatus 200.

FIG. 17 is a diagram illustrating an example of values stored on the product information DB 7 of the sales registration apparatus 200 in step S65.

FIG. 18 is a flowchart for illustrating an operation of the sales registration apparatus 200.

FIG. 19 is a diagram for illustrating a learning phase and a recognition phase in image recognition.

### DESCRIPTION OF EMBODIMENTS

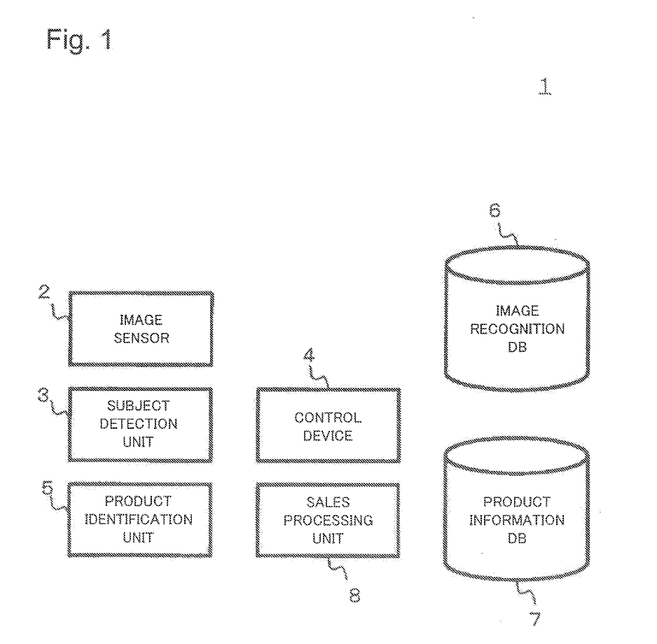

A sales registration apparatus 1 of an exemplary embodiment of the present invention will be described. The sales registration apparatus 1 is, for example, a POS (Point to Sales) cash register and executes sales registration of products. Referring to FIG. 1, the sales registration apparatus 1 includes an image sensor 2, a subject detection unit 3, a control device 4, a product identification unit 5, an image recognition Data Base (DB) 6, a product information DB 7, and a sales processing unit 8.

The image sensor 2 is a photoelectric conversion element such as a solid-state image-capturing element, and more specifically is a CCD (Charge-Coupled Device) image sensor or a CMOS (Complementary Metal-Oxide Semiconductor) image sensor. In an image-capturing range of the image sensor 2, there is, for example, a reading table, not illustrated, and an operator of the sales registration apparatus 1 places a product on the reading table so as to capture the product within the image-capturing range of the image sensor 2.

The subject detection unit 3 determines whether a subject (the product) is present within the image-capturing range of the image sensor 2. Various detection techniques are conceivable for a detection technique using the subject detection unit 3.

It is conceivable that, for example, an infrared LED (Light Emitting Diode) or a laser diode of a light source blinks at high speed with emitting light toward the image-capturing range of the image sensor 2 and a phase delay of reflective light reflected from the subject is measured to measure a distance to the subject. When the measured distance falls within the image-capturing range of the image sensor 2, the subject is detected as being present within the image-capturing range.

The distance may be measured using an ultrasound sensor. In this case, ultrasound is transmitted from a wave transmitter such as a piezoelectric ceramic toward the image-capturing range of the image sensor 2, and reflection thereof is received by a wave receiver such as another piezoelectric ceramic. A relation between a necessary time from the transmission of ultrasound to the reception of the reflection and a sound velocity is calculated by an operation device to measure a distance to a subject.

Alternatively, usable is a so-called stereo method for measuring a distance in accordance with the principle of triangulation by providing a plurality of image sensors or an active stereo method for executing measurement by replacing one image sensor with one light emitting device, instead of using two image sensors.

These detection techniques are achieved by measuring a distance to the subject, comparing the measured distance with a distance to the image-capturing range of the image sensor 2, and thereby determine whether the subject is present within the image-capturing range of the image sensor 2 using an operation processing device. Therefore, it is necessary to previously store, for distance measurement in each detection technique, a distance from a reference point to the image-capturing range of the image sensor 2 in a storage device accessible to the operation processing device that executes the determination. The reference point of distance measurement is a position of the light source in the technique based on a phase delay of reflective light and a position of the wave transmitter in the technique using the ultrasound sensor.

A frame image created by capturing a space in an image-capturing range using the image sensor 2 at all times may be compared with a previously prepared frame image in a state where there is nothing in the image-capturing range to determine the presence or absence of a subject.

The control device 4 is a control device that controls an operation of the sales registration apparatus 1. Specifically, when the subject detection unit 3 detects the presence of a subject within the image-capturing range of the image sensor 2, the control device 4 captures the subject by the image-sensor 2 to create a frame image. A number of frame images created upon detecting the subject within the image-capturing range of the image sensor 2 once is not limited to one and may be multiple numbers.

The product identification unit 5 outputs, when the subject placed within the image-capturing range of the image sensor 2 is a previously registered product, an identifier, i.e. a product ID indicating the product previously provided for the product. When it is difficult to identify the identified subject due to a reason that the subject does not correspond to any one of the registered products, a product ID previously determined for an unidentifiable product may be output.

A space that is in an image-capturing range by the image sensor 2 will be referred to as a space Vi. A space that is in a detection range of a subject by the subject detection unit 3 will be referred to as a space Vd. A space where the product identification unit 5 can identify a product will be referred to as a space Vr. At this time, the image sensor 2, the subject detection unit 3, and the product identification unit 5 are configured in such a way that the spaces Vi, Vd, and Vr are at least partially overlapped with each other. A space where the spaces Vi, Vd, and Vr are overlapped will be referred to as a space Vs.

Various techniques are conceivable as a technique for identification executed by the product identification unit 5. As the product identification unit 5, for example, a unit that identifies a product based on a bar code affixed to the product is conceivable. In this case, the product identification unit 5 includes a bar code reader that optically reads a bar code symbol affixed to a product and outputs corresponding code information and a storage device that stores a table for converting the code information read by the bar code reader to a product ID. An association relation between the product ID and the code information may be stored on the product information DB 7. Types of bar codes are not limited, and a striped bar code such as a JAN (Japanese Article Number) code, an EAN (European Article Number) code, and a UPC (Universal Product Code) code or a two-dimensional bar code such as a QR code (a registered trademark) is applicable.

Regarding the product identification unit 5, a unit that creates a frame image including character information such as a product name and a product ID described on a product itself or a package of the product to be read by a person using an image sensor and acquires the product ID by executing OCR (Optical Character Recognition) processing on the framed image may be employed as the product identification unit 5. The image sensor 2 may serve as the image sensor to be used at this time, or another image sensor may be prepared.

As the product identification unit 5, a unit that executes image recognition processing for a frame image of a subject created using the image sensor 2 or an image sensor separately provided for the sales registration apparatus 1 and acquires a product ID is applicable.

In this case, the product identification unit 5 includes an image recognition DB, a feature quantity operation processing device, a logic operation processing device. The image recognition DB is a database that previously stores a feature quantity calculated from an image of a product intended to be subjected to image recognition and a product ID of the product in association with each other. The image recognition DB 6 to be described later may also serve as the image recognition DB, or the image recognition DB may be separately provided. The feature quantity operation processing device calculates a feature quantity from a frame image created in the image sensor 2. The logic operation processing device acquires, from the image recognition DB 51, the product ID corresponding to the product in the frame image based on a comparison result between a feature quantity of each product previously stored on the image recognition DB and a feature quantity calculated from the frame image in the feature quantity operation processing device and outputs the acquired product ID.

There are various types of feature quantities in image recognition, but the present invention does not depend on a specific type of feature quantity. The feature quantity includes, for example, one based on the entire brightness distribution of a target object. The feature quantity includes one based on local information of a target object such as a Haar-like feature quantity, an EOH (Edge of Orientation Histograms) feature quantity, a HOG (Histograms of Oriented Gradients) feature quantity, or an Edgelet feature quantity. There is one based on linkage between local regions such as a Joint Haar-like feature quantity, a Shaplet feature quantity, or a Joint HOG feature quantity. In this manner, there are various types of feature quantities, but any feature quantity to be used in the present invention is applicable to the present invention.

In general, a feature quantity of an image is calculated based on pixel values of pixels configuring the image. In the present invention, a feature quantity may be calculated based on pixel values of all pixels configuring the image, or a feature quantity may be calculated based on pixel values of a predetermined part of pixels configuring the image. The pixel value refers to a value indicating a type and brightness of a color emitted by the pixel.

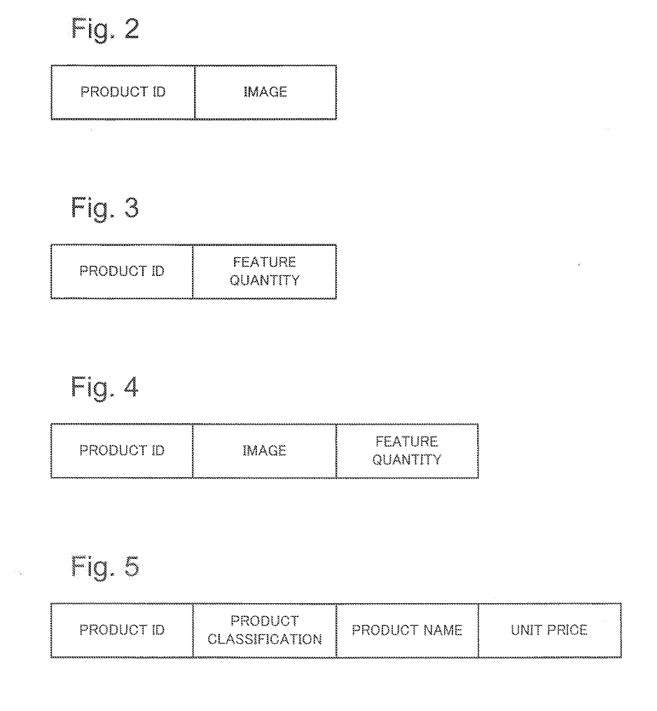

The image recognition DB 6 is a database for storing a frame image created in the image sensor 2 in accordance with a detection result by the subject detection unit 3 and a product ID output by the product identification unit 5 in association with each other. In this case, the image recognition DB 6 includes a record of a structure, for example, as illustrated in FIG. 2.

The sales registration apparatus 1 may further include a feature quantity operation processing device, not illustrated, that calculates a feature quantity based on a frame image. In this case, it is preferable for the image recognition DB 6 to store, together with the frame image or, instead of the frame image, the feature quantity calculated by the feature quantity operation processing device based on the frame image, a product ID output by the product identification unit 5 in association with each other. In general, a data amount of the feature quantity is smaller than a data amount of the frame image that is a source thereof, and therefore, when a feature quantity is stored instead of a frame image, a capacity necessary for the image recognition DB 6 can be reduced. When the feature quantity is stored in association with the product ID, the image recognition DB 6 includes a record of a structure, for example, as illustrated in FIG. 3. When both the feature quantity and the frame image are stored in association with the product ID, the image recognition DB 6 includes a record of a structure, for example, as illustrated in FIG. 4.

The product information DB 7 is a database that previously stores a product ID of a product and information about the product such as a selling source of the product, a product name, and a unit price in association with each other. The product information DB 7 is equivalent to a product master database used using a bar code of a PLU (Price Look Up) system. An example of a structure of a record of the product information DB 7 is illustrated in FIG. 5.

The sales processing unit 8 acquires, based on the product ID output by the product identification unit 5, at least a unit price of the product from the product information DB 7 and executes sales processing for the product. The sales processing determines, for example, a total amount based on the unit price acquired from the product information DB 7 with respect to each product identified in the product identification unit 5.

The sale processing unit 8 displays the product name, the unit price, the total amount, and the like acquired from the product information DB 7 for each product on a display device that is not illustrated, and prints these items as a receipt using a printer that is not illustrated.

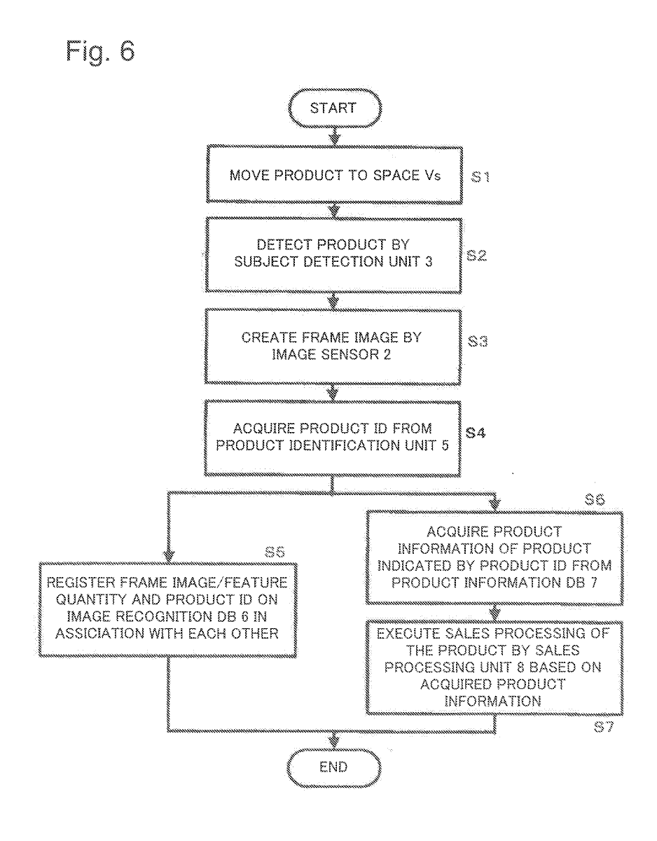

Next, with reference to FIG. 6, an operation of the sales registration apparatus 1 will be described.

An operator of the sales registration apparatus 1 picks up a product to be subjected to sales registration from a shopping basket or the like and moves the product to a space Vs where detection ranges of the image sensor 2, the subject detection unit 3, and the product identification unit 5 are overlapped (step S1).

The space Vs is also a part or the whole of a space Vd to be a detection range of a subject by the subject detection unit 3. When the subject detection unit 3 detects the presence of the product (step S2), the control device 4 creates a frame image obtained by capturing the product using the image sensor 2 (step S3).

The space Vs is also a part or the whole of a space Vi to be an image-capturing range by the image sensor 2, and therefore, when at this timing, a frame image is created, the product has been captured therein. In step S3, a plurality of frame images may be created for the same product. When the sales registration device 1 includes an operation processing device for calculating a feature quantity, a feature quantity may be calculated based on a created frame image.

After the frame image is completed to be created by the image sensor 2 or in parallel with creation of the frame image, the control device 4 identifies the product by the product identification unit 5 and acquires a product ID of the product (step S4).

The space Vs is also a part or the whole of the space Vr where the product identification unit 5 can identify the product, and therefore, frame image creation by the image sensor 2 and product identification by the product identification unit 5 may be executed simultaneously.

Although a predetermined plurality of frame images are required to be created, identification at the product identification unit 5 may be completed before all of the predetermined plurality of frame images are created. In such a case, the processing may move to a next step S5 by waiting for creation of the predetermined number of frame images.

The control device 4 then registers the frame image (or a feature quantity of the frame image) created in step S3 and the product ID acquired in step S4 on the image recognition DB 6 in association with each other (step S5).

The control device 4 acquires product information corresponding to the product ID acquired from the product identification unit 5 in step S4 from the product information DB 7 (step S6) and executes sales processing in the sales processing unit 8 (step S7).

In general, when a machine such as the product identification unit 5 is caused to recognize a product, it is necessary to directly face an appropriate direction of the product to a sensor of the machine. In a recognition technique based on a machine, for example, in a recognition based on optical reading of a bar code symbol affixed to a product, in a recognition based on identification of character information printed on a product package or like using OCR (Optical Character Recognition), or in a recognition based on image recognition technology used based on a comparison with a feature quantity calculated from an image of a product, it is necessary to face the above direction of the product to the sensor, and this is not different from each other. Hereinafter, such recognition techniques based on a machine will be collectively referred to as machine recognition.

When, for example, the product identification unit 5 executes recognition of a bar code, a reading unit of a bar code reader is required to directly face to a portion where the bar code of the product is written.

Even when the product identification unit 5 recognizes a product by image recognition, it is necessary to face a product in a suitable direction for image recognition toward an image sensor because there are suitable and unsuitable directions for image recognition of the product for each product.

Usually, an operator of a POS terminal knows such a relation between machine recognition of a product and a direction of the product, and therefore, when the product identification unit 5 does not correctly recognize a product, image recognition is caused to succeed by gradually changing a direction of the product.

Among skillful operators, there is an operator who empirically knows a direction likely to result in successful image recognition for a product and is therefore able to direct, in a stage prior to movement of the product to the space Vr, the product to an appropriate direction, but it is difficult for even such a skillful person to execute machine recognition in the same manner for all products. Specifically, for a product to be dealt with for the first time, even a skillful person needs trial and error for a direction of the product. In an operator with common skill and specifically a case of a so-called unmanned cash register in which a shopper him/herself operates a POS terminal as an operator, such trial and error frequently occurs.

The inventors have conceived the present invention by focusing attention to operations for a product at that time. In other words, when a product is subjected to machine recognition, many operators move the product to the inside of the space Vr where the product identification unit 5 can identify the product and thereafter rotate the product in various directions. When the produce is captured at that time, frame images in which the product is captured in various directions are obtained. Feature quantities are obtained from the respective frame images which are directed in the various directions, and these feature quantities are recorded on the image recognition DB 6 in association with a product ID obtained when the machine recognition succeeds thereafter.

According to such the sales registration apparatus 1, as a part of sales processing daily executed, at least one of an image of a product and a feature quantity can be newly registered on the image recognition DB 6. For even a product already registered on the image recognition DB 6, an image of the product captured at an angle different from that of a registered image or a feature quantity thereof can be added. As a result, it is possible to reduce or omit an image-capturing work of a product intended to only prepare learning result data, i.e. an image of the product and a feature quantity necessary upon executing image recognition.

### EXAMPLE 1

As one example, a sales registration apparatus 100 will be described. The sales registration apparatus 100 executes recognition by a bar code, adds a new product image/feature quantity to the image recognition DB 6, and executes image recognition based on the added product image/feature quantity. Functional blocks corresponding to the sales registration apparatus 1 described as the exemplary embodiment are assigned with the same reference signs.

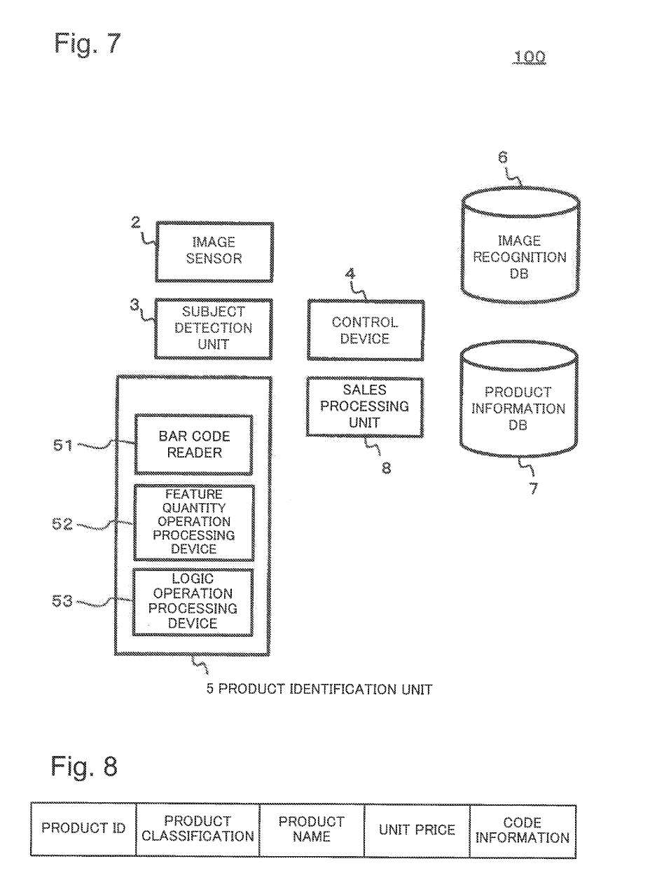

As illustrated in FIG. 7, the sales registration apparatus 100 includes a bar code reader 51 as the product identification unit 5. A product information DB 7 stores an association relation between code information read in the bar code reader 51 and a product ID. An example of a record structure of the product information DB 7 in this case is illustrated in FIG. 8. When the code information and the product ID are the same, the record structure of FIG. 5 can be used.

The product identification unit 5 identifies a product by image recognition and therefore includes a feature quantity operation processing device 52 and a logic operation processing device 53. The feature quantity operation processing device 52 calculates a feature quantity from a frame image created in an image sensor 2. The logic operation processing device 53 acquires, based on a comparison result between a feature quantity of each product previously stored on the image recognition DB 6 and the feature quantity calculated from the frame image in the feature quantity operation processing device 52, a product ID corresponding to a product in the frame image from the image recognition DB 6 and outputs the acquired product ID. It is assumed that the image recognition DB 6 stores an association relation between the product ID and the feature quantity as in the record structure illustrated in FIG. 3 or FIG. 4.

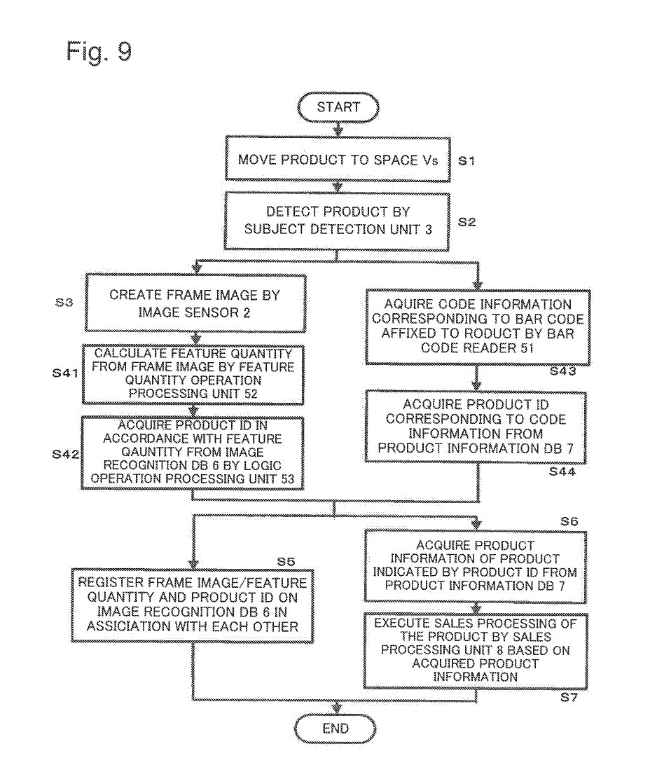

Next, an operation of the sales registration apparatus 100 will be described. The sales registration apparatus 100 operates as in FIG. 9, basically in the same manner as the sales registration apparatus 1. Steps in which the same operation is executed as in the flowchart of FIG. 6 are assigned with the same reference signs. In the present sample, the image sensor 2 can be classified also as a part of the product identification unit 5.

When movements from step S1 to step S3 are made and a frame image is created, the control device 4 creates a feature quantity from the frame image using the feature quantity operation processing device 52 (step S41). The control device 4 compares the created feature quantity and a feature quantity already registered on the image recognition DB 6 using the logic operation processing device 53 and acquires, from the image recognition DB 6, a product ID associated with a feature quantity that is the same as or close to the created feature quantity (step S42).

On the other hand, in parallel with steps S3, S41, and S42, the control device 4 reads a bar code symbol affixed to a product by the bar code reader 51 and acquires code information corresponding to the bar code symbol (step S43). The control device 4 acquires, from the product information DB 7, a product ID corresponding to the acquired code information (step S44).

In this manner, image recognition (steps S3, S41, and S42) for a frame image is executed or both the image recognition and bar code reading (steps S43 and S44) are executed in parallel, to acquire a product ID based on any one of the procedures.

Various methods are conceivable with respect to preferential employment of a product ID created by which one of the procedures. For example, simply, a first corner may be prioritized. In a situation where, for example, there are a small number of products in which a feature quantity thereof has already been registered on the image recognition DB 6, a number of products in which it is difficult to identify a product ID increases, resulting naturally in many cases where a product ID is acquired based on a bar code. Alternatively, it is possible that when after an elapse of a certain time from detection of a subject by a subject detection unit 3, a product ID has been obtained by any one of the procedures, the product ID is employed, and when a product ID has been obtained by both procedures, a product ID based on a bar code is prioritized.

In the same manner as in steps S5 to S7 of FIG. 6, the feature quantity created in the feature quantity operation device 52 based on the frame image is stored on the product image DB 6 in association with the product ID (step S5), and on the other hand, based on product information corresponding to the acquired product ID, a sales processing unit 8 executes sales processing (steps S6 and S7).

According to the sales registration apparatus 100 of the present sample, when feature quantities have not been sufficiently accumulated on the image recognition DB 6, with identification of a product based on a bar code and execution of sales processing, using an operation for rotating a product by an operator upon causing a bar code reader to read a bar code, the product is image-captured from multiple directions, frame images obtained by image-capturing the same product from multiple directions are created, feature quantities thereof are created, and the image recognition DB 6 is expanded. When the sales registration apparatus 100 is operated over a long period, feature quantities are accumulated on the image recognition DB 6 to the extent that a certain product can be recognized based on a feature quantity in any direction. Upon reaching this stage, even when the operator holds the product in the space Vs at any angle, a product ID of the product can be acquired by image recognition. As a result, the sales registration apparatus 100 can execute machine identification of a product, regardless of a direction of affixing a bar code, and therefore, a time necessary for sales registration processing can be reduced.

In the present sample, the bar code reader 51 has been described so as to be different from the image sensor 2, but the image sensor 2 may also serve as a bar code reader. In this case, further, an operation processing device that detects a bar code by analyzing a frame image created by the image sensor 2 and executes processing for converting the bar code to corresponding code information is necessary.

### Sample 2

In general, there are some products that can be hierarchically classified. For example, for an apple, which is a fruit, under an upper classification including a name of fruit referred to as “apple,” there are lower classifications including varieties such as “Kogyoku,” “Tsugaru,” and “Fuji.” In the same manner, for example, other fruit and vegetables can be classified into an upper classification and lower classifications. Usually, in a wholesale stage, a tag, a seal, or the like such as a bar code for identifying a product is not affixed to fruit or a vegetable, and therefore, in order to mechanically identify such a product and execute sales processing, a bar code or the like is previously affixed or identification is executed by image recognition.

In the present sample, a vegetable, fruit, or the like is identified by image recognition in an upper classification, and images and product information of lower classifications thereof are displayed for an operator to urge a selection input. While executing sales processing based on product information of the selected lower classification, the lower classification selected by the operator and a feature quantity of a frame image as a basis of the upper classification are added to an image recognition database in association with each other.

Continuation of such sales processing increases a number of registrations of feature quantities of the lower classifications in the image recognition database. With accumulation of feature quantities of the lower classifications, identification accuracy of the product in the lower classifications is improved.

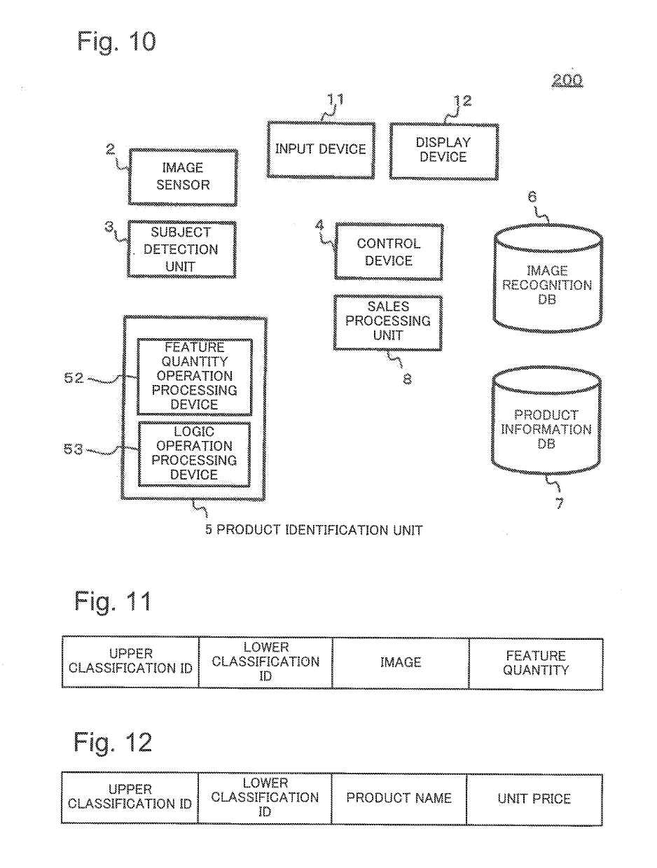

The sales registration apparatus 200 of the present sample will be described with reference to FIG. 10. To describe characteristic operations of the present sample, a fact that the sales registration apparatus 200 includes an input device 11 and a display device 12 is clearly illustrated. The input device 11 is a device that receives an input operation by an operator using a keyboard, a mouse, a ten key, a touch panel, or the like. The display device 12 is a device that displays text information and an image for the operator and a display device using, for example, a CRT (Cathode Ray Tube), a liquid crystal display, an organic EL (Electro-Luminescence) display, or the like.

In the present sample, a product ID is classified into two parts that are an upper classification ID and a lower classification ID. All products belonging to a certain upper classification are provided with the same upper classification ID. Lower classifications belonging to the upper classification are provided with lower classification IDs different from each other. A product ID indicating an upper classification itself is set, and therefore, regardless of what the upper classification is, a predetermined lower classification ID is set as a lower classification ID for indicating the upper classification itself.

It is assumed that, for example, all products belonging to an apple, which is a fruit, are provided with AAA as an upper classification ID. It is assumed that “Kogyoku,” “Tsugaru,” and “Fuji” that are lower classifications of apple are provided with 001, 002, and 0003 in this order, respectively, as lower classification IDs. A lower classification ID indicating the upper classification itself is designated as 000. At this time, product IDs of “Kogyoku,” “Tsugaru,” and “Fuji” are “AAA001,” “AAA002,” and “AAA003” in this order respectively. A product ID indicating the upper classification “apple” is “AAA000.”

Therefore, a record of the image recognition DB 6 has a structure, for example, as in FIG. 11. A record of the product information DB 7 has a structure, for example, as in FIG. 12.

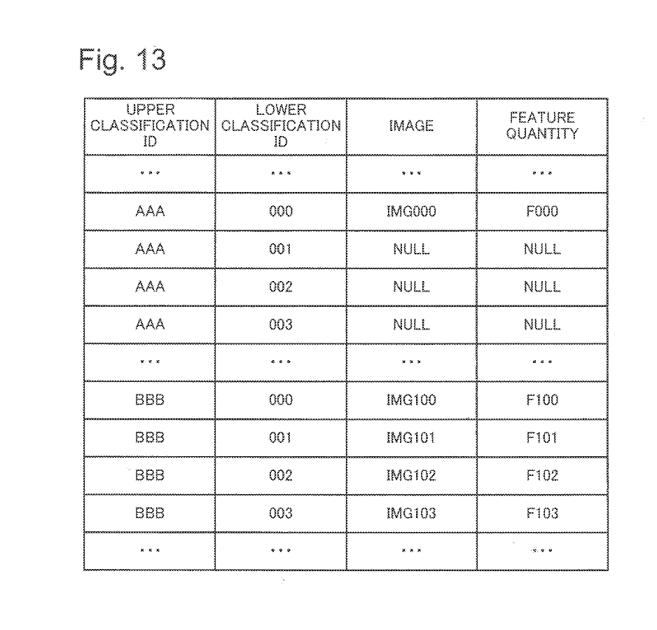

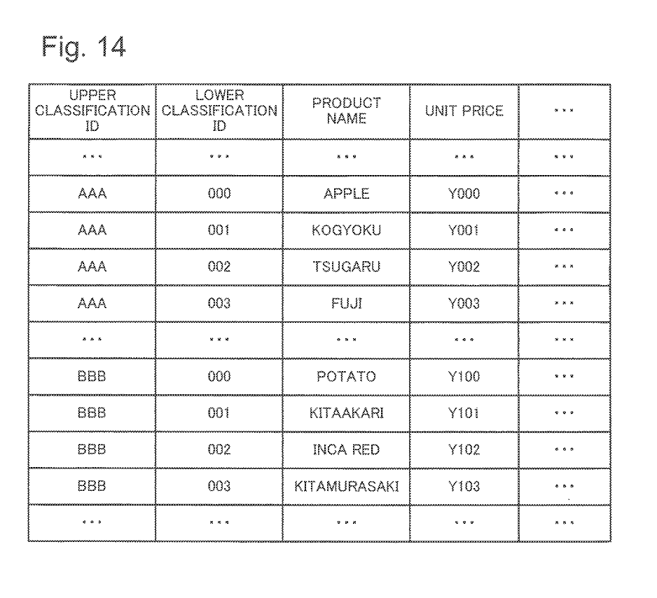

Next, an operation of the sales registration apparatus 200 will be described. It is assumed that a table as in FIG. 13 is currently stored on the image recognition DB 6. It is assumed that a table as in FIG. 14 is currently stored on the product information DB 7. In either table, other than the above-described example of apple, data regarding an upper classification “potato” in which “Kitaakari,” “Inca Red,” and “Kitamurasaki” are lower classifications is stored.

However, at the time prior to operations described below, on the image recognition DB 6, images and feature quantities of lower classifications of “apple” are unregistered. Therefore, it is assumed that in feature quantity fields of these lower classifications, a NULL value indicating unregistration is stored. Regarding lower classifications of “potato,” both images and feature quantities have already been registered.

A feature quantity of an upper classification is a feature quantity adapted to all products belonging to the upper classification. For example, a feature quantity “F000” of the upper classification “apple” is adaptable to the lower classifications “Kogyoku,” “Tsugaru,” and “Fuji” to some extent.

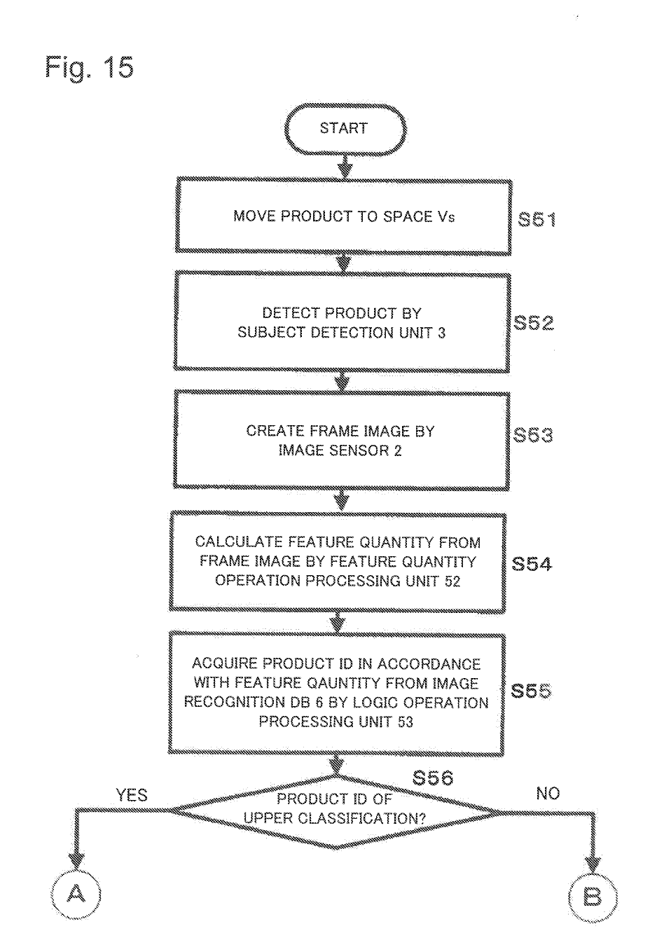

With reference to FIG. 15, description will be made. It is assumed that an operator has moved “Kogyoku” to the space Vs (step S51). In the sales registration apparatus 200, the following operations are executed under control by the control device 4. The subject detection unit 3 detects “Kogyoku” (step S52), the image sensor 2 creates a frame image including “Kogyoku” (step S53), and the feature quantity operation processing device 52 calculates a feature quantity based on the frame image (step S54). Here, it is assumed that “IMG001” has been created as a frame image and “F001” has been created as a feature quantity thereof.

The logic operation processing device 53 then compares the feature quantity “F001” created in step S54 and a feature quantity previously registered on the image recognition DB 6 and acquires a product ID of a corresponding product from the image recognition DB 6 (step S55).

As illustrated in FIG. 13, since a feature quantity of the lower classification is a NULL value, “Kogyoku” will not be output as a result of the image recognition. Instead, a feature quantity “F000” of “apple” that is the upper classification is matched as a closest value. Therefore, the logic operation processing device 53 acquires “AAA000” as a product ID from the image recognition DB 6. In the branch of step S56, “YES” is selected.

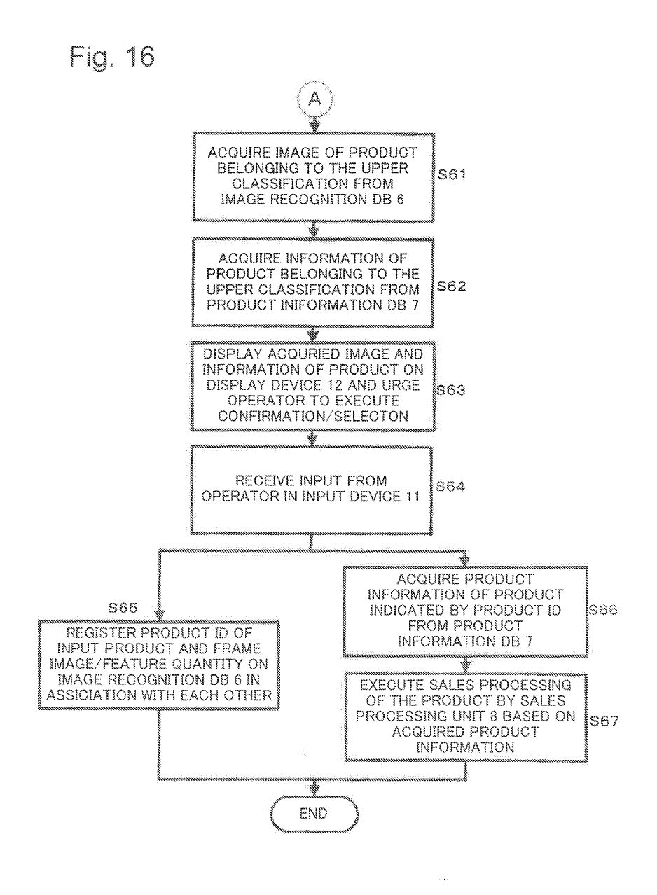

Referring to FIG. 16, the control device 4 acquires, when there are images of respective products belonging to the acquired product ID “AA000,” the images from the image recognition DB 6 (step S61). Product information such as product names and unit prices of the respective products belonging to the acquired product ID “AA000” is acquired from the product information DB 7 (step S62).

The images and the product information of the respective products belonging to the upper classification indicated by the product ID “AA000” are displayed on the display device 12, and a message urging for executing an input to confirm or select the product moved to the space Vs by the operator in step S51 among these products is displayed (step S63).

Here, respective pieces of product information of the lower classifications, i.e. “Kogyoku,” “Tsugaru,” and “Fuji” belonging to the upper classification “apple” are displayed. At this point in time, on the image recognition DB 6, images of the products of the lower classifications are not registered, and therefore, the images of the products are not displayed.

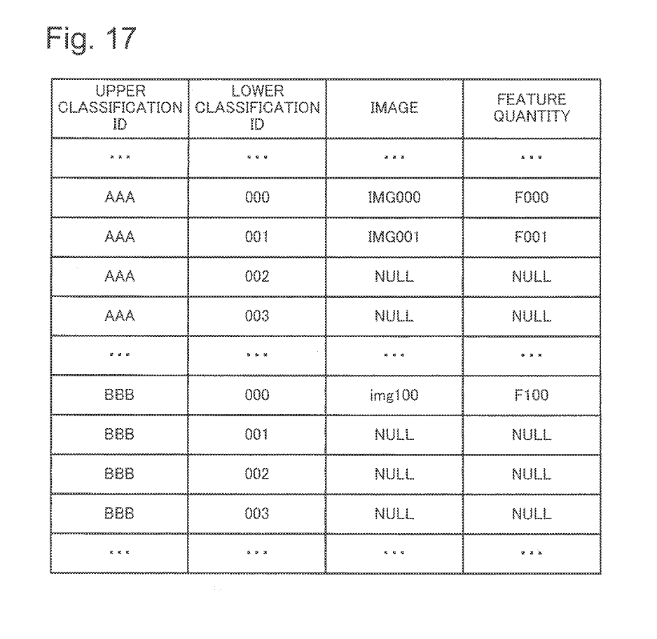

The operator views the product information of “Kogyoku,” “Tsugaru,” and “Fuji” displayed on the display device 12 and executes, from the input device 11, a selection input meaning a fact that “apple” having been subjected to image recognition by him/herself is “Kogyoku” (step S64). Upon reception of this input, the control device 4 registers, on the image recognition DB 6, a product ID, i.e. “AAA001” of the input “Kogyoku,” the frame image “IMG001” created in step S53, and the feature quantity “F001” calculated in step S54 in association with each other (step S65). After step S65, on the image recognition DB 6, a table as in FIG. 17 is stored. In parallel with step S65, the processing device 4 acquires product information of the product input in step S64 from the product information DB 7 (step S66) and executes sales processing of the product based on the product information in the sales processing unit 8 (step S67).

On the other hand, when the operator places, for example, “Inca Red” of “potato” in the space Vs, a feature quantity “F102” of “Inca Red” has already been registered on the image recognition DB 6, and therefore, a product ID “BBB002” obtained in step S15 belongs to a lower classification and “NO” is selected in step S56.

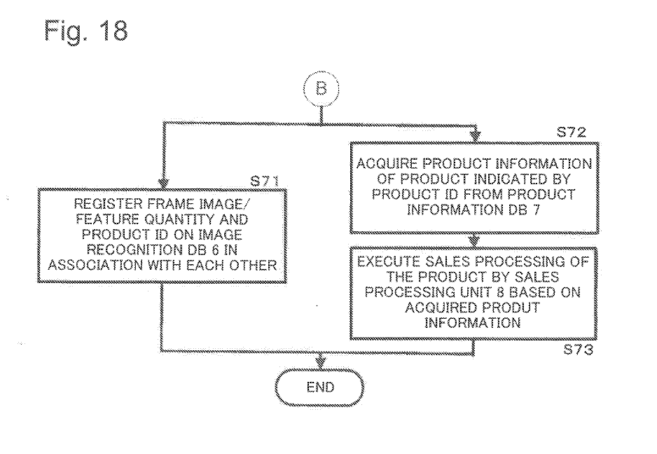

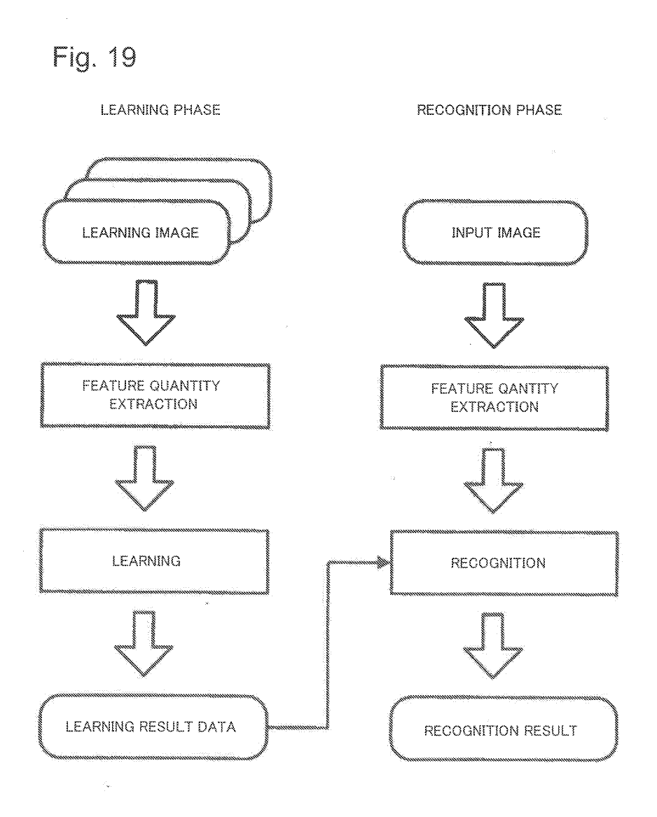

At this time, operations are executed as illustrated in FIG. 18. Steps S71 to S73 are basically the same as steps S5 to S7.

Description has been made as operations in which “Inca Red” is subjected to image recognition, and also regarding “Kogyoku” after new registration of the frame image “IMG001” and the feature quantity “F001” on the image recognition DB 6 in step S65 as described above, the same operations are executed. In other words, “Kogyoku” that has been mechanically identified merely as “apple” of the upper classification at first is mechanically identified as “Kogyoku” of a lower classification after executing sales processing.

In this manner, according to the sales registration apparatus 200, during continuous execution of sales processing, learning result data upon executing image recognition, i.e. feature quantities registered on the image recognition DB 6 are increased, and in addition, feature quantities can be accumulated so that image recognition can be executed by subdivision from an upper classification to lower classifications. Since this feature quantity accumulation is executed as a part of sales processing, a labor for accumulating learning result data can be reduced.

While the present invention has been described in line with the exemplary embodiment, the present invention is not limited thereto.

In the above-described exemplary embodiment and samples, description as a stand-alone sales registration apparatus has been made, but those skilled in the art could easily understand that the present invention is not limited thereto.

A configuration in which, for example, the image recognition DB 6 and the product information DB 7 are disposed on a server on a LAN (Local Area Network) or a WAN (Wide Area Network) and other function blocks are included in a network terminal, the present invention is also feasible. Also when the image recognition DB 6 and the product information DB 7 disposed on a network in this manner are shared among a plurality of such network terminals, the present invention is feasible.

A form in which the sales registration apparatus 100 having been described as Sample 1 is used as a basis and a function thereof is distributed to a client computer and a server computer (hereinafter, expressed as a client and a server, respectively) is described below. At this time, the client and the server each include a network interface device, and are connected to each other via a LAN or WAN so that data communication is possible. The image sensor 2, the subject detection unit 3, the control device 4, the bar code reader 51, and the sales processing unit 8 in the sales registration apparatus 100 are included in the client, and on the other hand, the feature quantity operation processing device 52, the logic operation processing device 53, the image recognition DB 6, and the product information DB 7 are included in the server.

When an information processing system including such a client and a server is configured, a plurality of clients can use a single server. Therefore, the feature quantity operation processing device 52, the logic operation processing device 53, the image recognition DB 6, and the product information DB 7 can be shared among a plurality of clients. As a result, learning result data can be collected from a plurality of clients and accumulated on a single server.

A part or all of the exemplary embodiment can be described as the following supplementary notes but the present invention is not limited thereto.

### (Supplementary Note 1)

A sales registration apparatus including:

capturing means for creating an image by capturing a subject;

identification means for acquiring an identifier relating to a product that is the subject; and

storage means for storing, upon execution of both creation of the image by the capturing means and acquisition of the identifier by the identification means for sales processing as a trigger, at least one of the image and a feature quantity created based on the image and the identifier in association with each other.

### (Supplementary Note 2)

The sales registration apparatus according to Supplementary Note 1, further including sales processing means for acquiring product information of the product based on an identification result generated by the identification means and executing sales processing of the product based on the acquired sales information.

### (Supplementary Note 3)

The sales registration apparatus according to any one of Supplementary Note 1 and Supplementary Note 2,

wherein the capturing means further includes detection means for creating an image by capturing a space in a predetermined image-capturing range and detecting a presence of the subject within the image-capturing range, and

wherein the capturing means creates an image in accordance with detection of the subject by the detection means.

### (Supplementary Note 4)

The sales registration apparatus according to any one of Supplementary Note 1 to Supplementary Note 3, wherein when it is difficult to identify the product, the identification means acquires a predetermined identifier for an unidentifiable product.

### (Supplementary Note 5)

The sales registration apparatus according to any one of Supplementary Note 1 to Supplementary Note 4, including a bar code reader in the identification means.

### (Supplementary Note 6)

The sales registration apparatus according to any one of Supplementary Note 1 to Supplementary Note 5, wherein the identification means includes an image recognition means for acquiring the identifier from the storage means based on a comparison between any one of a feature quantity calculated based on a frame image previously stored in the storage means and a feature quantity previously stored in the storage means and a feature quantity calculated from a frame image created in an image sensor.

### (Supplementary Note 7)

The sales registration apparatus according to Supplementary Note 6, including, as a target of sales registration, a product classified into an upper classification and one or a plurality of lower classifications belonging to the upper classification, and the sales registration apparatus including

image recognition means for acquiring, based on a comparison between any one of a feature quantity created from a frame image of the product of an upper classification previously stored in the storage means and a feature quantity of the product of the upper classification previously stored in the storage means and a feature quantity calculated from a frame image created in the image sensor, the identifier of another product classified into a lower classification from the storage means.

### (Supplementary Note 8)

The sales registration apparatus according to any one of Supplementary Note 1 to Supplementary Note 7,

wherein the identification means includes

both a bar code reader and image recognition means, the image recognition means acquiring the identifier from the storage means based on a comparison between any one of a feature quantity calculated based on the one or the plurality of frame images previously stored in the storage means and a feature quantity previously stored in the storage means and a feature quantity calculated from a frame image created in an image sensor, and

wherein the image recognition means identifies a product based on a content stored in the storage means by prioritizing an identification result by the bar code reader.

### (Supplementary Note 9)

An information processing device connectable, via a network, to another information processing device, the information processing device including:

image-capturing means for creating an image by capturing a subject, and

identification means for acquiring an identifier relating to a product that is the subject,

the information processing device further including storage means for storing, upon execution of both creation of the image by the capturing means and acquisition of the identifier by the identification means for sales processing as a trigger, at least one of the image and a feature quantity created based on the image and the identifier in association with each other.

### (Supplementary Note 10)

The information processing device according to Supplementary Note 9, further including image recognition means for acquiring the identifier from the storage means based on a comparison between any one of a feature quantity calculated based on an image previously stored in the storage means and a feature quantity previously stored in the storage means and a feature quantity calculated from the image created in the capturing means.

### (Supplementary Note 11)

The information processing device according to Supplementary Note 10, further including image recognition means for acquiring, based on a comparison between any one of a feature quantity created from an image of the product of an upper classification previously stored in the storage means and a feature quantity of the product of the upper classification previously stored in the storage means and a feature quantity calculated from an image created in the capturing means, the identifier of the product classified into a lower classification belonging to the upper classification from the storage means.

### (Supplementary Note 12)

The information processing device according to any one of Supplementary Note 9 to Supplementary Note 11,

wherein the another information processing device includes a bar code reader,

wherein the information processing device includes image recognition means acquiring the identifier from the storage means based on a comparison between any one of a feature quantity calculated based on an image previously stored in the storage means and a feature quantity previously stored in the storage means and a feature quantity calculated from the image created in the capturing means, and

wherein the image recognition means identifies the product based on a content stored in the storage means by prioritizing an identification result by the bar code reader.

### (Supplementary Note 13)

An information processing system including:

image-capturing means for creating an image by capturing a subject;

identification means for acquiring an identifier relating to a product that is the subject; and

storage means storing, upon execution of both creation of the image by the capturing means and acquisition of the identifier by the identification means for sales processing as a trigger, at least one of the image and a feature quantity created based on the image and the identifier in association with each other.

### (Supplementary Note 14)

The information processing system according to Supplementary Note 13, further including sales processing means for acquiring product information of the product based on an identification result by the identification means and executing sales processing of the product based on the acquired sales information.

### (Supplementary Note 15)

The information processing system according to any one of Supplementary Note 13 and Supplementary Note 14,

wherein the capturing means further includes detection means for creating an image by capturing a space in a predetermined image-capturing range and detecting the presence of the subject within the image-capturing range, and

wherein the capturing means creates the image in accordance with detection of the subject by the detection means.

### (Supplementary Note 16)

The information processing system according to any one of Supplementary Note 13 to Supplementary Note 15, wherein when it is difficult to identify a product, the identification means acquires a predetermined identifier for the unidentifiable product.

### (Supplementary Note 17)

The information processing system according to any one of Supplementary Note 13 to Supplementary Note 16, including a bar code reader in the identification means.

### (Supplementary Note 18)

The information processing system according to any one of Supplementary Note 13 to Supplementary Note 17, wherein the identification means includes an image recognition means for acquiring the identifier from the storage means based on a comparison between any one of a feature quantity calculated based on a frame image previously stored in the storage means and a feature quantity previously stored in the storage means and a feature quantity calculated from a frame image created in an image sensor.

### (Supplementary Note 19)

The information processing system according to Supplementary Note 18, including, as a target of sales registration, a product classified into an upper classification and one or a plurality of lower classifications belonging to the upper classification, the information processing system including

image recognition means for acquiring, based on a comparison between any one of a feature quantity created from a frame image of the product of an upper classification previously stored in the storage means and a feature quantity of the product of the upper classification previously stored in the storage means and a feature quantity calculated from a frame image created in the image sensor, the identifier of another product classified into a lower classification from the storage means.

### (Supplementary Note 20)

The information processing system according to any one of Supplementary Note 13 to Supplementary Note 19,

wherein the identification means includes,

both a bar code reader and image recognition means,

the image recognition means acquiring the identifier from the storage means based on a comparison between any one of a feature quantity calculated based on an image previously stored in the storage means and a feature quantity previously stored in the storage means and a feature quantity calculated from the image created in the capturing means, and

wherein the image recognition means identifies the product based on a content stored in the storage means by prioritizing an identification result by the bar code reader.

### (Supplementary Note 21)

A program causing a computer to function as:

capturing means for creating an image by capturing a subject;

identification means for acquiring an identifier relating to a product that is the subject; and

storage means for storing, upon execution of both creation of the image by the capturing means and acquisition of the identifier by the identification means for sales processing as a trigger, at least one of the image and a feature quantity created based on the image and the identifier in association with each other.

### (Supplementary Note 22)

The program according to Supplementary Note 21, further causing the computer to function as sales processing means for acquiring product information of the product based on an identification result generated by the identification means and executing sales processing of the product based on the acquired sales information.

### (Supplementary Note 23)

The program according to any one of Supplementary Note 21 and Supplementary Note 22,

wherein the capturing means further causes the computer to function as detection means for creating an image by capturing a space in a predetermined image-capturing range and detecting a presence of the subject within the image-capturing range, and

wherein the capturing means creates an image in accordance with detection of the subject by the detection means.

### (Supplementary Note 24)

The program according to any one of Supplementary Note 21 to Supplementary Note 23, wherein when it is difficult to identify the product, the identification means acquires a predetermined identifier for an unidentifiable product.

### (Supplementary Note 25)

The program according to any one of Supplementary Note 21 to Supplementary Note 24, executing identification based on an output of a bar code reader in the identification means.

### (Supplementary Note 26)

The program according to any one of Supplementary Note 21 to Supplementary Note 25, causing the computer to further function as the identification means, by image recognition means for acquiring the identifier from the storage means based on a comparison between any one of a feature quantity calculated based on a frame image previously stored in the storage means and a feature quantity previously stored in the storage means and a feature quantity calculated from a frame image created in an image sensor.

### (Supplementary Note 27)

The program according to Supplementary Note 26, causing the computer to further function as image recognition means for acquiring, based on a comparison between any one of a feature quantity created from an image of the product of an upper classification previously stored in the storage means and a feature quantity of the product of the upper classification previously stored in the storage means and a feature quantity calculated from an image created in the capturing means, the identifier of the product classified into a lower classification belonging to the upper classification from the storage means.

### (Supplementary Note 28)

The program according to any one of Supplementary Note 21 to Supplementary Note 27, causing the computer to further function as the identification means, by both identification based on an output of a bar code reader and an image recognition means, the image recognition means acquiring the identifier from the storage means based on a comparison between any one of a feature quantity calculated based on the one or the plurality of frame images previously stored in the storage means and a feature quantity previously stored in the storage means and a feature quantity calculated from a frame image created in the image sensor, and

wherein the image recognition means identifies the product based on a content stored on the storage means by prioritizing an identification result by the bar code reader.

### (Supplementary Note 29)

A sales registration method including:

a capturing stage of creating an image by capturing a subject;

an identification stage of acquiring an identifier relating to a product that is the subject; and

a storage stage of storing, upon execution of both creation of the image by the capturing stage and acquisition of the identifier by the identification stage for sales processing as a trigger, at least one of the image and a feature quantity created based on the image and the identifier in association with each other.

### (Supplementary Note 30)

The sales registration method according to Supplementary Note 29, further including a sales processing stage of acquiring product information of the product based on an identification result by the identification stage and executing sales processing of the product based on the acquired sales information.

### (Supplementary Note 31)

The sales registration method according to any one of Supplementary Note 29 and Supplementary Note 30,

wherein the capturing stage further includes a detection stage of creating the image by capturing a space in a predetermined image-capturing range and detecting the presence of the subject within the image-capturing range, and

wherein the capturing stage creating the image in accordance with detection of the subject by the detection stage.

### (Supplementary Note 32)

The sales registration method according to any one of Supplementary Note 29 to Supplementary Note 31, wherein when it is difficult to identify the product, the identification stage acquires a predetermined identifier for an unidentifiable product.

### (Supplementary Note 33)

The sales registration method according to any one of Supplementary Note 29 to Supplementary Note 32, including reading a bar code by a bar code reader in the identification means.

### (Supplementary Note 34)

The sales registration method according to any one of Supplementary Note 29 to Supplementary Note 33, including, as the identification stage, an image recognition stage of acquiring the identifier from the storage stage based on a comparison between any one of a feature quantity calculated based on a frame image previously stored in the storage stage and a feature quantity previously stored in the storage stage and a feature quantity calculated from a frame image created in the image sensor.

### (Supplementary Note 35)

The sales registration method according to Supplementary Note 34, including, as a target of sales registration, a product classified into an upper classification and one or a plurality of lower classifications belonging to the upper classification, the method including

an image recognition stage of acquiring, based on a comparison between any one of a feature quantity created from a frame image of a product of an upper classification previously stored in the storage stage and a feature quantity of the product of the upper classification previously stored in the storage stage and a feature quantity calculated from a frame image created in the image sensor, the identifier of a product classified into a lower classification from the storage stage.

### (Supplementary Note 36)

The sales registration method according to any one of Supplementary Note 29 to Supplementary Note 35,

wherein the identification stage includes,

both a stage of reading a bar code by a bar code reader; and an image recognition stage, the image recognition stage of acquiring the identifier from the storage stage based on a comparison between any one of a feature quantity calculated based on the one or the plurality of frame images previously stored in the storage stage and a feature quantity previously stored in the storage stage and a feature quantity calculated from a frame image created in the image sensor, and

wherein the image recognition stage identifies a product based on a content stored in the storage stage by prioritizing an identification result by the bar code reader.

This application is based upon and claims the benefit of priority from Japanese patent application No. 2014-068502, filed on Mar. 28, 2014, the disclosure of which is incorporated herein in its entirety by reference.

1. A sales registration apparatus comprising:
capturing unit configured to create an image by capturing a subject;
identification unit configured to acquire an identifier relating to a product that is the subject; and
storage unit configured to store, upon execution of both creation of the image by the capturing means and acquisition of the identifier by the identification means for sales processing as a trigger, at least one of the image and a feature quantity created based on the image and the identifier in association with each other.

2. The sales registration apparatus according to claim 1, further comprising sales processing unit configured to acquire product information of the product based on an identification result generated by the identification means and executing sales processing of the product based on the acquired sales information.

3. The sales registration apparatus according to claim 1, wherein
the capturing means further comprises detection unit configured to create an image by capturing a space in a predetermined image-capturing range and detect a presence of the subject within the image-capturing range, and
wherein the capturing means creates an image in accordance with detection of the subject by the detection means.

4. The sales registration apparatus according to claim 1, wherein, when it is difficult to identify the product, the identification means acquires a predetermined identifier for an unidentifiable product.

5. The sales registration apparatus according to claim 1, comprising a bar code reader in the identification means.

6. The sales registration apparatus according to claim 1, wherein the identification means comprises an image recognition unit configured to acquire the identifier from the storage means based on a comparison between any one of a feature quantity calculated based on a frame image previously stored in the storage means and a feature quantity previously stored in the storage means and a feature quantity calculated from a frame image created in an image sensor.

7. The sales registration apparatus according to claim 6, comprising, as a target of sales registration, a product classified into an upper classification and one or a plurality of lower classifications belonging to the upper classification, and the sales registration apparatus comprising
image recognition unit configured to acquire, based on a comparison between any one of a feature quantity created from a frame image of the product of an upper classification previously stored in the storage means and a feature quantity of the product of the upper classification previously stored in the storage means and a feature quantity calculated from a frame image created in the image sensor, the identifier of another product classified into a lower classification from the storage means.

8. The sales registration apparatus according to claim 1, comprising:
wherein the identification means comprises,
both a bar code reader and image recognition means, the image recognition unit configured to acquire the identifier from the storage means based on a comparison between any one of a feature quantity calculated based on the one or the plurality of frame images previously stored in the storage means and a feature quantity previously stored on the storage means and a feature quantity calculated from a frame image created in an image sensor, and
wherein the image recognition means identifies a product based on a content stored in the storage means by prioritizing an identification result by the bar code reader.

9. An information processing device connectable, via a network, to another information processing device, the information processing device comprising:
capturing unit configured to create an image by capturing a subject, and
identification unit configured to acquire an identifier relating to a product that is the subject,
the information processing device further comprising storage unit configured to store, upon execution of both creation of the image by the capturing means and acquisition of the identifier by the identification means for sales processing as a trigger, at least one of the image and a feature quantity created based on the image and the identifier in association with each other.

10. An information processing system comprising:
capturing unit configured to create an image by image-capturing a subject;
identification unit configured to acquire an identifier relating to a product that is the subject; and
storage unit configured to store, upon execution of both creation of the image by the capturing means and acquisition of the identifier by the identification means for sales processing as a trigger, at least one of the image and a feature quantity created based on the image and the identifier in association with each other.

11. A non-transitory computer-readable storage medium storing a program causing a computer to function as:
capturing unit configured to create an image by capturing a subject;
identification unit configured to acquire an identifier relating to a product that is the subject; and
storage unit configured to store, upon execution of both creation of the image by the capturing means and acquisition of the identifier by the identification means for sales processing as a trigger, at least one of the image and a feature quantity created based on the image and the identifier in association with each other.

12. A sales registration method comprising:
creating an image by capturing a subject;
acquiring an identifier relating to a product that is the subject; and
storing, upon execution of both creation of the image by the capturing stage and acquisition of the identifier by the identification stage for sales processing as a trigger, at least one of the image and a feature quantity created based on the image and the identifier in association with each other.
